(19) United States
(12) Patent Application Publication
(10) Pub. No.: US 2007/0036650 A1
(43) Pub. Date: Feb. 15, 2007

(54) Rotor and system

(76) Inventor: Billy Lau, Walnut, CA (US)

Correspondence Address: Billy Lau, 486 Vista Del Norte, Walnut, CA, 91789-1605, US

(21) Appl. No.: 11/503,003

(22) Filed: Aug. 12, 2006

Related U.S. Application Data
(60) Provisional application No. 60/707,860, filed on Aug. 13, 2005.

(51) Int. Cl. F03D 11/00

(52) U.S. Cl. 416/5

(57) ABSTRACT

According to an embodiment of the invention, a lighted vertical axis rotor comprises a rotor that is suitable for vertical axis operations and at least one light source on the rotor. A lighted vertical axis rotor system comprises a support structure, a rotor that is suitable for vertical axis operations and rotatably attached to this support structure, and at least one light source on the rotor. In selected embodiments, the support structure is suitable to be mounted on, for example, a vehicle, a vehicle window, a vehicle antenna, the top of a vehicle antenna, a vehicle window mounted flag assembly, the top of a vehicle window mounted flagpole, the trunk of a vehicle, or the hood of a vehicle.

### CROSS -REFERENCE TO RELATED APPLICATION

This application claims the benefit of Provisional Patent Application Ser. No. 60/707,860 filed on Aug. 13, 2005, which is incorporated by reference herein.

### FIELD OF THE INVENTION

This invention generally relates to a lighted rotor and a system that employs the lighted rotor. Particularly, this invention relates to a lighted vertical axis rotor and a system that employs lighted vertical axis rotors.

### BACKGROUND

A turbine coverts the flow energy in a fluid into rotational energy. A wind turbine converts wind energy into rotational energy. The rotor on the wind turbine converts the linear motion of wind into rotational energy and rotates about a rotational axis in operation. This rotational energy has numerous applications, including for example, driving a generator, a pump, or an anemometer. There are two types of wind turbines: the horizontal axis wind turbine and the vertical axis wind turbine. The horizontal axis wind turbine employs a horizontal axis rotor. The horizontal axis rotor converts the linear motion of wind that is substantially in a direction that is parallel to the rotational axis of the horizontal axis rotor into rotational energy. Representative examples of a horizontal axis wind turbine include a propeller-type windmill and a pinwheel, which is a wind-driven rotating toy.

The vertical axis wind turbine employs at least one vertical axis rotor. The vertical axis rotor converts the linear motion of wind that is substantially in the directions that are perpendicular to the rotational axis of the vertical axis rotor into rotational energy. A representative rotor comprises at least one working surface, which the wind pushes against. Many representative rotor designs employ a large number of working surfaces. Examples of the working surface of a rotor include for example: a rotor blade, a rotor sails, or an anemometer cup. An axle on the rotational axis of the rotor links the rotor to the other structure of the wind turbine. The axle is a part of the rotor in some rotor designs and not a part of the rotor in some other rotor designs. Vertical axis rotors are rotors that are designed to be suitable for vertical axis operations. Unlike a horizontal axis rotor, a vertical axis rotor is not efficient in converting the linear motion of wind in the direction parallel to the axis of rotation into rotational energy and therefore not suitable for horizontal axis operations. Similarly, horizontal axis rotor is not suitable for vertical axis operations because it is not efficient in converting the linear motion of wind in the directions perpendicular to the axis of rotation into rotational energy. In windmill applications, a horizontal axis wind turbine requires a mechanism to align the horizontal axis rotors with the wind direction for the horizontal axis wind turbine to work properly but a vertical axis turbine does not need such mechanism. This is a well know advantage of a vertical axis wind turbine.

Representative examples of a vertical axis rotor include but are not limited to the Savonius rotor disclosed in U.S. Pat. No. 1,697,574 and U.S. Pat. No. 1,766,765 both to Savonius, the split Savonius rotor, the cup anemometer rotor, the Darrieus rotor disclosed in U.S. Pat. No. 1,835,018 to Darrieus, the H-Darrieus rotor, the V-Darrieus rotor, the Giromill rotor, the flapping plate rotor, or the plate rotor. There are a large number of patents that teach vertical axis wind turbine, including for example: U.S. Pat. No. 1,697,574 and U.S. Pat. No. 1,766,765 both to Savonius, U.S. Pat. No. 1,835,018 to Darrieus, U.S. Pat. No. 2,596,726 to Rydell, U.S. Pat. No. 3,093,194 to Rusconi, U.S. Pat. No. 3,942,909 to Yengst, and U.S. Pat. No. 4,293,274 to Gilman. Vertical axis wind turbine designs are readily adaptable to work in any moving fluid such as water. A vertical axis rotor may be employed in a vertical axis turbine for any fluid, including for example, air or water. Further, some vertical axis rotors may be driven to move a fluid, including for example, air or water, in a direction or directions that are substantially perpendicular to their axes of rotation. The rotational axis of a rotor, including a vertical axis rotor, may be oriented in any direction, including the vertical direction and horizontal directions.

### SUMMARY

According to an embodiment of the invention, a lighted vertical axis rotor comprises a rotor that is suitable for vertical axis operations and at least one light source on the rotor. A lighted vertical axis rotor system, including for example a light vertical axis wind turbine, comprises a support structure, a rotor that is suitable for vertical axis operations and rotatably attached to this support structure, and at least one light source on the rotor. In selected embodiments, the support structure is suitable to be mounted on, for example, a vehicle, a vehicle window, a vehicle antenna, the top of a vehicle antenna, a vehicle window mounted flag assembly, the top of a vehicle window mounted flagpole, the trunk of a vehicle, or the hood of a vehicle.

### DESCRIPTION OF THE DRAWINGS

A better understanding of the invention may be gained from the consideration of the following detailed descriptions taken in conjunction with the accompanying drawings in which:

FIGS. 1A and 1B show a simplified top view and a simplified side view of an embodiment of the present invention.

FIGS. 2A and 2B show a simplified top view and a simplified cutaway view of an alternative embodiment of the present invention.

FIGS. 3A and 3B show a simplified top view and a simplified side view of another alternative embodiment of the present invention.

### DETAILED DESCRIPTION OF THE INVENTION

In the description that follows, like parts are indicated throughout the specification and drawings with the same reference numerals. The present invention is not limited to the specific embodiments illustrated herein.

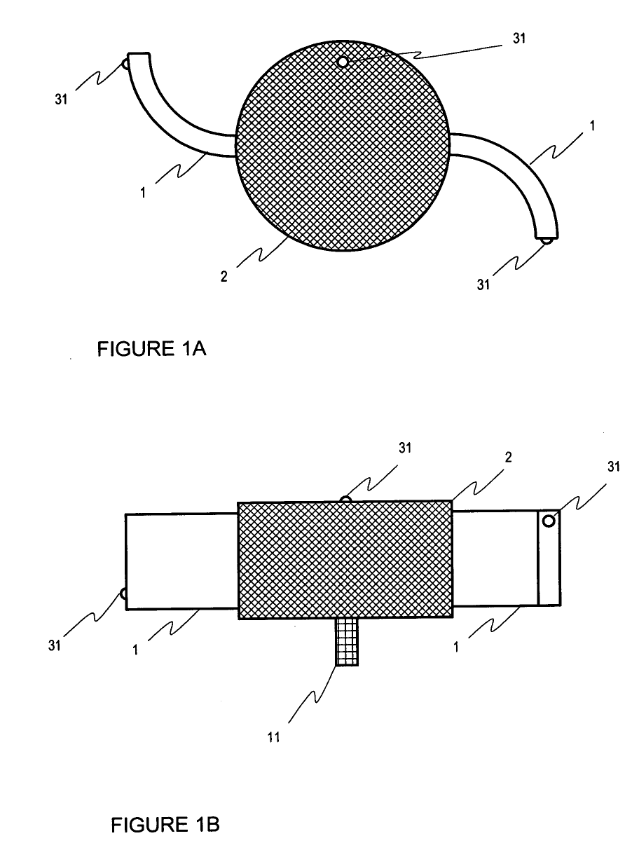

FIG. 1A shows a simplified top view and FIG. 1B shows a simplified side view of an embodiment of the present invention. Referring to FIG. 1A, blades 1 are the two working surfaces of the embodiment. Blades 1 are attached to a cylindrical shaped hub 2. Blades 1 and hub 2 form the vertical axis rotor of this embodiment. Referring to FIG. 1B, axle 11 links hub 2 to the structure of a vertical axis rotor system such as a vertical wind turbine, which is not shown in the figures. When a fluid moves across blades 1 in a direction that has a component in a direction that is perpendicular to the axis of rotation pass blades 1, the embodiment rotates. On the hub 2 and blade 1, there are light sources 31. Optionally, hub 2 or blades 1 are light-transmissive and light 31 are inside hub 2 or blades 1. Although there are multiple light sources 31 illustrated in FIGS. 1A and 1B, there may be only one light source 31. Light source 31 may be an electrically powered light source or a chemiluminescent light source. Optionally a battery system that include at least on battery in hub 2 provides power to light source 31. Alternatively, each light source has an internal power source. Light sources 31 may be controlled by a controller in hub 2 to display predetermined light patterns. The controller may receive information from one or more optional sensors and control light sources 31 according to the information from the sensors. Examples of sensor may include but are not limited to light sensor, motion sensor, and proximity sensor, acoustic sensor, angular position encoder, and Light controller, sensors are commercial-off-the-self items. Light control techniques are know to the ones skill in the art of light control and therefore do not require an explanation. A simple control scheme is to turn on the light source the display a predetermined light pattern sequence when the controller sense hub 2 is rotating and turn off light sources 31 after hub 2 stop rotating on a predetermined time period. Another simple control scheme is to turn off light source 31 when the ambient light is above a predetermined level. Selected combinations of control schemes are also possible. Note that this embodiment inherits a well known advantage of a vertical axis wind turbine, which is that this embodiment does not require any mechanism to align the rotor axis of the embodiment with the wind direction for the embodiment to work properly.

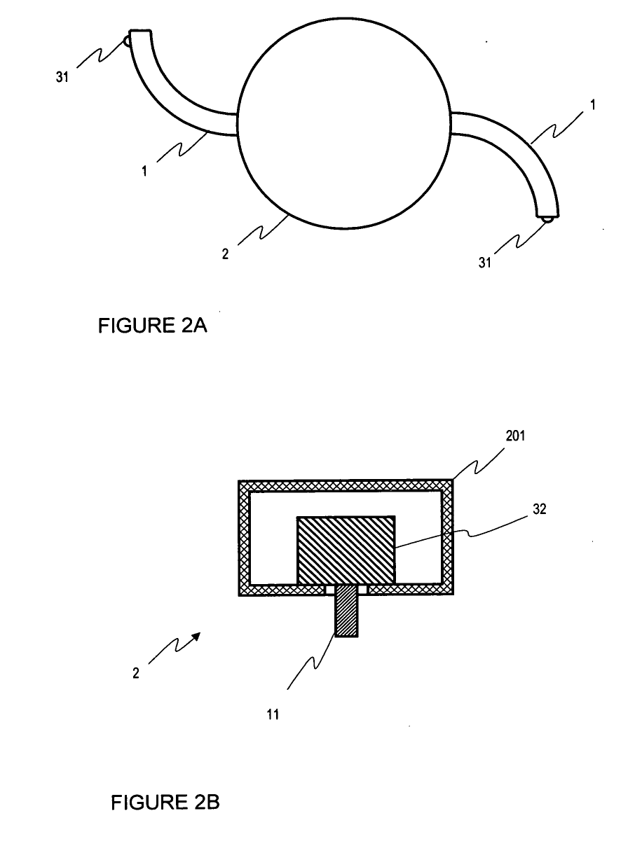

FIG. 2A shows a simplified top view and FIG. 2B shows a simplified cutaway view of an alternative embodiment of the present invention. The alternative embodiment shown in FIGS. 2A and 2B is similar to the embodiment shown in FIGS. 1A and 1B except that there is a generator in hub 2 of the alternative embodiment shown in FIGS. 2A and 2B. Referring to FIG. 2B, hub 2 comprises hub housing 201 and generator 32. Axle 11 is also the axle of generator 32. Power from generator 32 may power light source 31 directly or indirectly through a controller. When a fluid moves across blades 1 in a direction that has a component in a direction that is perpendicular to the axis of rotation pass blades 1, the embodiment rotates about axle 11 and generator 32 generates electricity.

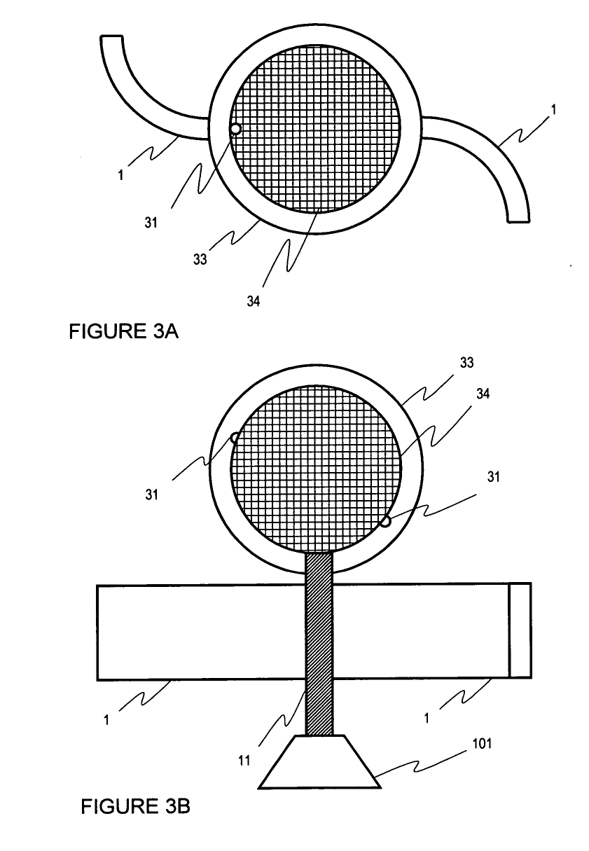

FIG. 3A shows a simplified top view and FIG. 3B shows a simplified side view of another alternative embodiment of the present invention. Referring to FIG. 3A, blades 1 are the two working surfaces of this embodiment. Blades 1 are attached to axle 11. On the top end of axles 11 is a transparent sphere 33. Inside transparent sphere 33 is a sphere 34. On sphere 34 is at least one light source 31. Axle 11 attaches to a base 101 through a bearing or other schemes. Optionally there is a slip ring subsystem on axle 11 transmitting power from base 101 to light source 31. Slip ring subsystems are common known to ones who are skilled in electric machinery or electric power generation and therefore do not require an explanation. Alternative to the configuration shown in FIGS. 3A and 3B, blades 1 may be attached to axle 11 on the top end and lights 31 are attached directly or directly to axle 11.

Optionally, base 101, a support structure, may be adapted for permanent or removable attachment to on a object such as, for example: a house, a window, a door, a roof top, a flat surface, a vehicle, including for example, on a vehicle window, on a vehicle antenna, on the tip of a vehicle antenna, on a vehicle-window-mounted flag, on the tip of the flagpole of a vehicle-window-mounted flag, on the trunk, on the hood, on a boat, on a bicycle, and on a car. Support structures that include a hook or a clip may be employed to latch on to a window, a door, the trunk or the hood of a vehicle, and other objects. This type of support structure design is employed in numerous commercial off-the-self products, such as a vehicle-window-mounted flag. Support structures that include a magnet may be employed to removably attach this type of support structure to an object made form a ferromagnetic metal, including for example the body of a car or truck. There are numerous commercial of-the-self products the employ this type of support structure. Support structures that have a hole for receiving a rod or the tip of a rod may be used to attach this type of support structure to an antenna, a flagpole, and a rod shaped object mounted on a vehicle. There are numerous commercial of-the-self products, including for example an antenna ball, that employ this type of support structure. Locking screws are commonly employed in this type of support structure. Although the above support structure types are primarily employed for removable attachment to an object, they can be easily adapted for permanent attachment to the object; for example, by applying an adhesive. Because support structures that are suitable for attaching to an object are widely known to one skilled in the art, they do not require further explanation.

There are numerous variations to the embodiments discussed above which will be trivial to the one skilled in the art. Examples of these variations include but not limited to:
Examples of light source 31 include but are not limited to a incandescent light source, a light emitting diode, a electroluminescent light source, a florescent light source, a solid state light source, or a chemiluminescent light source;
Lights source 31 may receive power from hub 2 through a controller;
Lights source 31 may emit multiple color;
Light sources 31 of different color are on the vertical axis rotor;
Light source 31 may be powered by a battery system on the vertical axis rotor, or a generator on the vertical axis rotor driven by the vertical axis rotor, or power source external to the vertical axis rotor, or a solar panel on the vertical axis rotor, or a battery system on the vertical axis rotor charge by a generator on the vertical axis rotor driven by the vertical axis rotor, or power source external to the vertical axis rotor, or a solar panel on the vertical axis rotor, or a selected combination thereof;
Each light source 31 may have its own controller, sensors, or power source;
An embodiment may include axle 11;
Examples of vehicle include but are not limited a car, a boats, a bicycle, a motorcycle, and a truck;
The vertical axis rotor may be support on both end of axle 11, for example, like in the conventional Savonius or Darrieus wind turbine;
The application of the embodiments of the present inventions is not limited to vertical axis wind turbines;
Controller may be responsive to wireless signals such as radio frequency or light signal;
Light pattern of light sources 31 may be externally programmable;
Inductive power transmission between base 101 and the vertical axis rotor may be employed;
Generator on the vertical axis rotor may employ a split-design in which the coils of the generator are mounted in the vertical axis rotor and magnets of the generator are mounted outside the vertical axis rotor on a stationary structure is know to one skilled in the art and may be use here;
Generator may be arranged to charge a battery system on the vertical axis rotor and this battery system supplies power to the lights source 31 on the vertical axis rotor, a battery charging system may be necessary for improved performance;
Generator may include a mechanism such as a gear system that is arranged to allow the vertical axis rotor and the generator to run at differently angular speed;
The vertical axis rotor may drive a generator on the support structure and the electricity from this generator is transmitted back to the vertical axis rotor to power the light source 31 through, for example, a slip ring system or inductive coupling;
The number of working surfaces on a vertical axis rotor may be greater than two;
Examples application of the embodiments of the present inventions include but are not limited to, ornamental display apparatus, toys, wind turbine, and water turbine; and
A combination or subcombination of the above.

Although the embodiment of the invention has been illustrated and that the form has been described, it is readily apparent to those skilled in the art that various modifications may be made therein without departing from the spirit of the invention.

What is claimed is:

1. A lighted vertical axis rotor, comprising:
a rotor being suitable for vertical axis operations; and
at least one light source being disposed on said rotor.

2. A lighted vertical axis rotor as claimed in claim 1, wherein, said light source comprises a light emitting diode.

3. A lighted vertical axis rotor as claimed in claim 1, wherein, said lighted vertical axis rotor is suitable to be removably attached to a vehicle.

4. A lighted vertical axis rotor as claimed in claim 1, wherein, said rotor comprises:
a hub; and
at least one working surface extending from said hub.

5. A lighted vertical axis rotor as claimed in claim 4, wherein, said light source is disposed on said hub.

6. A lighted vertical axis rotor as claimed in claim 4, wherein, said light source is disposed on said working surface.

7. A lighted vertical axis rotor as claimed in claim 1 further comprises a power source on said rotor being disposed to power said light source.

8. A lighted vertical axis rotor as claimed in claim 7, wherein, said power source is selected from a set consisting of:
a battery system;
a generator on said rotor being driven by said rotor; and
a battery system receiving power from a generator on said rotor being driven by said rotor.

9. A lighted vertical axis rotor as claimed in claim 1 further comprises a controller on said rotor being disposed to control said light source through controlling the power flow from said power source to said light source.

10. A lighted vertical axis rotor as claimed in claim 9 further comprises a sensor being disposed so that said controller is responsive to the information from said sensor.

11. A lighted vertical axis rotor as claimed in claim 10, wherein, said sensor comprises a light sensor being disposed so that said controller is responsive to the ambient light level and controls the power flow to said light source according the ambient light level.

12. A lighted vertical axis rotor as claimed in claim 10, wherein, said sensor comprises a motion sensor being disposed so that said controller is responsive to the motion of said rotor.

13. A lighted vertical axis rotor as claimed in claim 1 further comprises a plurality of light sources of a plurality of colors on said rotor.

14. A lighted vertical axis rotor, comprising:
a rotor being suitable for vertical axis operations; and
a plurality of light sources being disposed on said rotor.

15. A lighted vertical axis rotor as claimed in claim 14, wherein, said plurality of light sources comprises light emitting diodes.

16. A lighted vertical axis rotor as claimed in claim 14, wherein, said lighted vertical axis rotor is suitable to be removably attached to a vehicle.

17. A lighted vertical axis rotor as claimed in claim 14, wherein, said plurality of light sources comprises light sources of at least two colors.

18. A lighted vertical axis rotor as claimed in claim 14, wherein:
said rotor comprises:
a hub; and
a plurality of working surfaces; and
said plurality of light sources is disposed on one selected from the set consisting of said hub and said plurality of working surfaces.

19. A lighted vertical axis rotor as claimed in claim 14 further comprises a power source on said rotor being disposed to power said light sources.

20. A lighted vertical axis rotor as claimed in claim 19, wherein, said power source is selected from a set consisting of:
a battery system;
a generator on said rotor being driven by said rotor; and
a battery system receiving power from a generator on said rotor being driven by said rotor.

21. A lighted vertical axis rotor as claimed in claim 14 further comprises a controller on said rotor being disposed to control said light sources to display light patterns through controlling the power flow from said power source to said light sources.

22. A lighted vertical axis rotor as claimed in claim 21 further comprises a sensor being disposed so that said controller is responsive to the information from said sensor.

23. A lighted vertical axis rotor as claimed in claim 22, wherein, said sensor comprises a light sensor being disposed so that said controller is responsive to the ambient light level and controls the power flow to said light sources according the ambient light level.

24. A lighted vertical axis rotor as claimed in claim 22, wherein, said sensor comprises a motion sensor being disposed so that said controller is responsive to the motion of said rotor.

25. A lighted vertical axis rotor system, comprising:
a support structure;
a rotor being suitable for vertical axis operations rotatably attaching to said support structure; and
at least one light source being disposed on said rotor.

26. A lighted vertical axis rotor system as claimed in claim 25, wherein, said light source comprises a light emitting diode.

27. A lighted vertical axis rotor system as claimed in claim 25, wherein, said support structure is suitable to be attached onto one selected from the set consisting of a vehicle, a vehicle window, a vehicle antenna, the tip of a vehicle antenna, a vehicle window-mounted flag, the tip of the flagpole of a vehicle window-mounted flag, the trunk of a vehicle, the hood of a vehicle.

28. A lighted vertical axis rotor system as claimed in claim 25, wherein further comprises a plurality of light sources of a plurality of colors on said rotor.

29. A lighted vertical axis rotor system as claimed in claim 25, wherein, said rotor comprises:
a hub; and
at least one working surface.

30. A lighted vertical axis rotor system as claimed in claim 29, wherein, said light source is disposed on said hub.

31. A lighted vertical axis rotor system as claimed in claim 29, wherein, said light source is disposed on said working surface.

32. A lighted vertical axis rotor system as claimed in claim 25 further comprises a power source on said rotor being disposed to power said light source.

33. A lighted vertical axis rotor system as claimed in claim 32, wherein, said power source is selected from a set consisting of:
a battery system;
a generator on said rotor being driven by said rotor; and
a battery system receiving power from a generator on said rotor being driven by said rotor.

34. A lighted vertical axis rotor system as claimed in claim 25 further comprises a controller on said rotor being disposed to control said light source through controlling the power flow from said power source to said light source.

35. A lighted vertical axis rotor system as claimed in claim 34 further comprises a sensor being disposed so that said controller is responsive to the information from said sensor.

36. A lighted vertical axis rotor system as claimed in claim 35, wherein, said sensor comprises a light sensor being disposed so that said controller is responsive to the ambient light level and controls the power flow to said light source according the ambient light level.

37. A lighted vertical axis rotor as claimed in claim 25, wherein, said sensor comprises a motion sensor being disposed so that said controller is responsive to the motion of said rotor.

38. A lighted vertical axis rotor system as claimed in claim 25 further comprises a plurality of light sources of a plurality of colors on said rotor.
